(19) United States
(12) Patent Application Publication
(10) Pub. No.: US 2025/0315630 A1
(43) Pub. Date: Oct. 9, 2025

(54) AUTOMATIC PROMPT GENERATION BASED ON A MEETING DISCUSSION

(71) Applicant: Google LLC, Mountain View, CA (US)

(72) Inventors: Ethan Samuel Shernan, Snoqualmie, WA (US); Yan Liu, Sammamish, WA (US); Dmitry Denisovich Levin, Sammamish, WA (US); Jan Arvid Kristoffer Callas, Sammamish, WA (US)

(21) Appl. No.: 19/172,454

(22) Filed: Apr. 7, 2025

Related U.S. Application Data
(60) Provisional application No. 63/631,320, filed on Apr. 8, 2024.

(51) Int. Cl. G06F 40/40; G06F 40/166; G06F 40/35; G06Q 10/1093

(52) U.S. Cl. CPC G06F 40/40; G06F 40/166; G06F 40/35; G06Q 10/1097

(57) ABSTRACT

Aspects of the disclosure are directed to automatic prompt generation based on a meeting discussion. A live transcript of a virtual meeting is obtained while a virtual meeting is being conducted. The live transcript includes current content discussed by participants of the virtual meeting. A determination is made based on the live transcript of whether the current content indicates a request of a participant for an operation to be performed with respect to the virtual meeting. Responsive to a determination that the current content indicates the request of the participant for the operation, one or more of a context or a sentiment associated with the request is identified. A prompt for an artificial intelligence (AI) model is generated based on the request and the one or more of the context or the sentiment. The AI model is trained to perform the operation with respect to the virtual meeting.

### CLAIM OF PRIORITY

The present application claims the benefit under 35 U.S.C. §119(e) of U.S. Provisional Patent Application No. 63/631,320 filed Apr. 8, 2024, which is incorporated by reference herein.

### TECHNICAL FIELD

Aspects and implementations of the present disclosure relate to automatic prompt generation based on a meeting discussion.

### BACKGROUND

A platform can enable users to connect with other users through a video-based or audio-based virtual meeting (e.g., a conference call). The platform can provide tools that allow multiple client devices to connect over a network and share each other's audio data (e.g., a voice of a user recorded via a microphone of a client device) and/or video data (e.g., a video captured by a camera of a client device, etc.) for efficient communication.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes obtaining, while a virtual meeting is being conducted, a live transcript of the virtual meeting. The live transcript includes current content discussed by participants of the virtual meeting. The method further includes determining, based on the live transcript, whether the current content indicates a request of a participant for an operation to be performed with respect to the virtual meeting. The method further includes, responsive to determining that the current content indicates the request of the participant for the operation, identifying one or more of a context or a sentiment associated with the request. The method further includes generating, based on the request and the one or more of the context or the sentiment, a prompt for an artificial intelligence (AI) model. The AI model is trained to perform the operation with respect to the virtual meeting.

In some implementations, the operation includes at least one of preparing meeting minutes associated with the virtual meeting, preparing a meeting summary associated with the virtual meeting, generating tasks out of action items corresponding to one or more discussion points of the live transcript, storing meeting notes associated with the virtual meeting for later reference, presenting an electronic document via a user interface (UI) of a client device of the participant, or generating a response to a question of the participant.

In some implementations, the method further includes obtaining the live transcript of the virtual meeting includes detecting, during the virtual meeting, an audio signal representing one or more verbal statements of a respective participant. The method further includes providing the audio signal as an input to a transcription engine. The method further includes obtaining one or outputs of the transcription engine. The one or more outputs include a textual version of the one or more verbal statements of the respective participant. The method further includes updating the live transcript of the virtual meeting to include the textual version of the one or more verbal statements.

In some implementations, determining whether the current content indicates a request of the participant for the operation includes providing at least a portion of the live transcript as an input to an intent classifier model. The method further includes obtaining one or more outputs of the intent classifier model. The one or more outputs include an indication of whether the portion of the live transcript includes a reference to one or more operations to be performed with respect to the virtual meeting. The determination of whether the current content indicates the request of the participant is made based on the obtained one or more outputs of the intent classifier model.

In some implementations, identifying one or more of the context or the sentiment associated with the request includes providing at least a portion of the live transcript as an input to a discussion context model. The method further includes obtaining one or more outputs of the discussion context model. The one or more outputs include an indication of at least one of a predicted context or a predicted sentiment of a discussion corresponding to the at least the portion of the live transcript. The identified one or more of the context or the sentiment associated with the request includes the at least one of the predicted context or the predicted sentiment.

In some implementations, the method further includes updating a user interface (UI) of a client device associated with the participant to include a UI element corresponding to the operation with respect to the virtual meeting. The live transcript of the virtual meeting includes an indication of a detection of a user interaction with the UI element. Determining whether the current content indicates the request of the participant for the operation to be performed with respect to the virtual meeting is based on the indication of the detection of the user interaction with the UI element.

In some implementations, the method further includes determining a set of operations pertaining to one or more of an additional context or an additional sentiment associated with prior content of the live transcript, the set of operations include the operation. The method further includes updating the UI to include a set of UI elements each corresponding to a respective operation of the set of operations. The set of UI elements include the UI element corresponding to the operation.

In some implementations, generating the prompt for the AI model includes providing the request and the one or more of the context or the sentiment as an input to a prompt generator model. The method further includes obtaining one or more outputs of the prompt generator model. The one or more outputs include one or more prompts and, for each of the one or more prompts, an indication of a level of confidence that a respective prompt corresponds to an optimized prompt for the request. The method further includes determining that the prompt for the AI model is associated with a level of confidence that satisfies one or more confidence criteria.

In some implementations, the method further includes identifying a pre-defined prompt template that corresponds to at least one of a meeting type associated with the virtual meeting or an operation type associated with the operation. The prompt for the AI model is further generated based on the identified pre-defined prompt template.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example meeting resource engine, in accordance with implementations of the present disclosure.

FIG. 3 depicts a flow diagram of an example method for generating a meeting summary of a virtual meeting, in accordance with implementations of the present disclosure.

FIG. 4 depicts a flow diagram of an example method for automatic prompt generation based on a meeting discussion, in accordance with implementations of the present disclosure.

FIG. 5 is a block diagram of example AI model(s) associated with generating a prompt, in accordance with implementations of the present disclosure.

FIGS. 6A-6C illustrate example user interfaces (UIs), in accordance with implementations of the present disclosure.

FIG. 7 illustrates an example predictive system, in accordance with implementations of the present disclosure.

FIG. 8 is a block diagram illustrating an exemplary computer system, in accordance with implementations of the present disclosure.

### DETAILED DESCRIPTION OF THE DRAWINGS

Aspects of the present disclosure relate to automatic prompt generation based on a meeting discussion. A platform can enable users to connect with other users through a video or audio-based virtual meeting (e.g., a conference call, etc.). During or after a virtual meeting, participants may want to review key information associated with the virtual meeting discussion, clarify action items discussed during the meeting, and/or ensure alignment on decisions made by the participants during the meeting. While using conventional virtual meeting platforms to conduct virtual meetings, such participants may manually take notes on the discussion topics in order to capture the above information. However, manually taking notes can be burdensome, as it can cause a participant to divide their attention between actively participating in the meeting and memorializing points of interest. It can take a significant amount of time for a user to update manually created meeting notes and, in some instances, other participants of the virtual meeting may pause the discussion until the participant has completed updating the meeting notes and has rejoined the discussion. During such time when the discussion is paused, computing resources (e.g., processing cycles, network resources, memory resources, etc.) can be consumed (e.g., by the platform, by client devices of the participants, etc.) to maintain the virtual meeting environment. Such resources are unavailable for other processes, which can increase an overall latency and decrease an overall efficiency of the system.

Additionally, a participant who joins a virtual meeting after the meeting has started can experience confusion related to meeting discussions (e.g., a current meeting topic, material presented during the meeting, whether such participant's input was requested prior to the user joining the meeting, etc.) and may not be able to provide input on the points being discussed. Such participant may interrupt the current discussion to ask the other participants questions about what was previously discussed, which can interrupt the flow of the discussion and therefore cause the virtual meeting to take a longer period of time (e.g., in order to ensure that all points intended for discussion during the virtual meeting are addressed). By extending the duration of the virtual meeting, additional computing resources are consumed (e.g., by the platform, by the client devices, etc.), which can further increase the overall latency and decrease the overall efficiency of the system.

Implementations of the present disclosure address the above and other deficiencies by providing methods and systems for automatic generation of a prompt (e.g., for an artificial intelligence (AI) model) based on a meeting discussion. As described herein, the prompt can cause an AI model to perform one or more operations with respect to a virtual meeting, which can prevent or otherwise mitigate participants of the virtual meeting performing such tasks.

In some embodiments, a platform (e.g., a virtual meeting platform) can provide users with access to tools or functionalities associated with the automatic generation of meeting resources pertaining to a virtual meeting. A meeting resource can include meeting minutes, a meeting summary, an action item (e.g., or list or action items) corresponding to a context or a sentiment of a virtual meeting discussion. Such tools or functionalities are described herein as an “automated meeting resource” feature. In some embodiments, before or during a virtual meeting, a participant of the virtual meeting can initiate the automated meeting resource feature. (e.g., by engaging with one or more user interface (UI) elements of a UI associated with the virtual meeting, by providing a verbal or textual command associated with initiating the automated meeting resource feature, etc. Upon initiation of the automated resource feature, the platform can obtain a live transcript (e.g., a transcript reflecting verbal and/or textual statements of the participants that is generated in real-time or approximately real-time) of a discussion of the virtual meeting and, as will be seen below, can perform one or more operations associated with the context and/or the sentiment of the meeting discussion, in some embodiments.

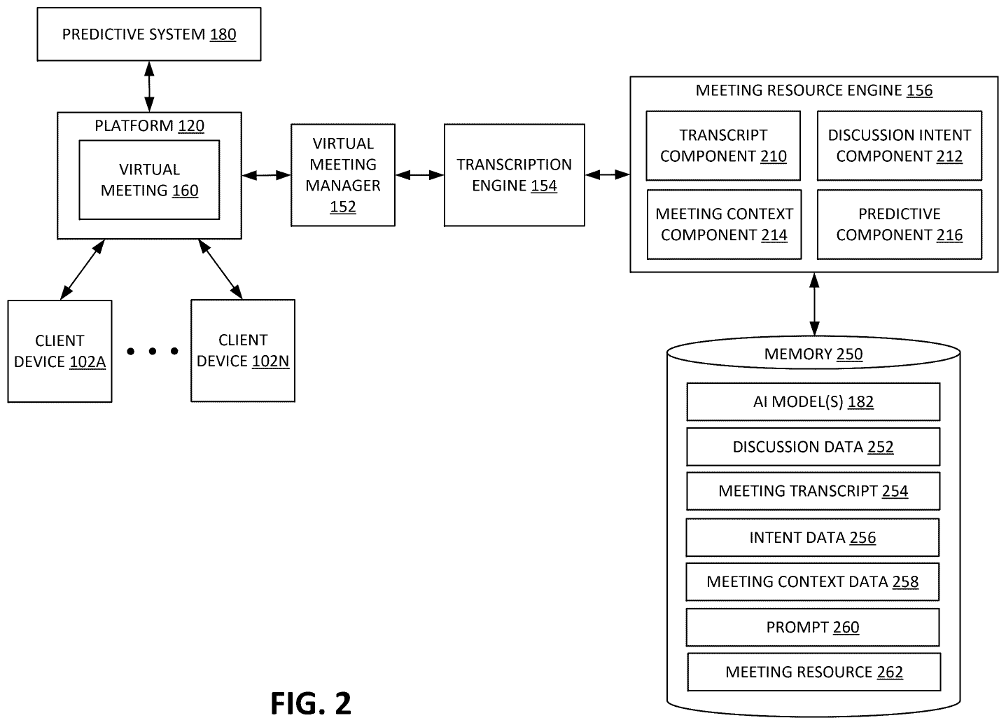

As indicated above, the platform can obtain a live transcript of the virtual meeting, which includes content (e.g., current content that is being discussed and/or prior content that was discussed) by participants of the virtual meeting. The platform can determine, based on the live transcript, whether the content indicates a request of a participant for an operation to be performed with respect to the virtual meeting. An operation can include, but is not limited to, preparing meeting minutes associated with the virtual meeting, preparing a meeting summary associated with the virtual meeting, generating tasks out of action items corresponding to one or more discussion points of the live transcript, storing meeting notes associated with the virtual meeting for later reference, presenting an electronic document via a UI of a client device of a participant, or generating a response to a question of the participant. In some embodiments, the platform can determine whether the content indicates the request for performance of the operation by providing at least a portion of the live transcript as an input to an intent classifier model. The intent classifier model may be trained to predict an intent of a verbal statement and/or a textual statement provided by a participant of a virtual meeting discussion. The platform can obtain one or more outputs of the intent classifier model, which can include an indication of whether the portion of the live transcript includes a reference to one or more operations to be performed with respect to the virtual meeting. The platform can determine whether the content includes the request to perform the operation based on the one or more outputs of the intent classifier model. Further details regarding the intent classifier model and determining whether content of a live transcript includes a request for performance of an operation are provided herein with respect to FIGS. 2-5.

In some embodiments, responsive to determining that the current content indicates the request of the participant for the operation, the platform can identify a context and/or a sentiment associated with the request. A context associated with the request refers to a background, topic, or issue being addressed during the virtual meeting discussion in a time period prior to or when the request was made. The context can include, but is not limited to, a relevant part of the discussion, the participants involved, goals or challenges discussed, and/or any decisions or agreements that led to the request. In some instances, the context of the request can indicate or otherwise provide clarity as to why the operation is being requested and how it connects to the objectives of the virtual meeting. A sentiment associated with the request refers to the emotional tone or attitude conveyed by the participant when the request was made. A sentiment may be neutral, positive (e.g., expressed with enthusiasm or agreement), urgent (e.g., reflecting time-sensitivity or importance), and so forth. In some instances, the sentiment of the request can indicate the priority behind the request and/or how it should be addressed or followed up. In some embodiments, the platform can identify the context and/or the sentiment associated with the request by providing at least a portion of the live transcript associated with the request as an input to a discussion context model and extracting the context and/or sentiment from one or more outputs of the discussion context model. Further details regarding the discussion context model and identifying the context and/or the sentiment of the request are provided herein with respect to FIGS. 2-5.

In some embodiments, the platform can generate a prompt for an AI model based on the request and the context and/or sentiment. A prompt refers to an instruction that, when provided as an input to an AI model, causes the AI model to provide a specific response or output. In some embodiments, the prompt can cause the AI model to perform the operation in accordance with the request based on the context and/or sentiment. In some embodiments, the platform can generate the prompt by providing the context and/or sentiment as an input to a prompt generator model, which is tried to generate prompts based on given input data. The one or more outputs of the prompt generator model can include one or more prompts and, for each prompt, an indication of a level of confidence that the respective prompt is an optimized prompt in view of the request and the context and/or sentiment of the request. An optimized prompt refers to a prompt that is expected to cause the AI model to provide an outcome associated with a high degree of accuracy (e.g., exceeding a threshold degree of accuracy) and/or perform the operation within a minimal amount of time and/or using a minimal number of computing resources (e.g., processing cycles, memory space, etc.). The platform can obtain the prompt by identifying the prompt that is associated with a level of confidence that satisfies one or more confidence criteria. In other or similar embodiments, the platform can generate the prompt based on a pre-defined prompt template associated with a type of the virtual meeting and/or a type of the operation of the request. Further details regarding generating the prompt are provided herein with respect to FIGS. 2-5.

Upon generating the prompt, the platform can provide the prompt as an input to an AI model (e.g., a large language model (LLM)) that is trained to perform the operation of the request. Based on the provided prompt, the AI model can perform the operation, and the platform can provide an outcome of the operation for presentation to one or more participants of the virtual meeting. In an illustrative example, the operation can correspond to generating a task out of an action corresponding to a discussion point of the live transcript. In such example, the prompt for the AI model can indicate the request to generate the task, the action item corresponding to the task, a context of the request (e.g., what was discussed prior to or when the request to generate the task was received), and/or a sentiment of the request (e.g., whether the request was provided with a sense of urgency, etc.). The prompt generated for the request can reflect the requested operation, the context of the request and/or the sentiment of the request, which can cause the AI model to perform the operation in accordance with the request. For example, the task generated by the AI can reflect the action item and, in some embodiments, can reflect the urgency and/or other points of the discussion when the request was provided. The outcome of the operation can be included in a meeting resource (e.g., meeting notes, a meeting summary, etc.) which is provided for presentation to the participants during the virtual meeting and/or after the virtual meeting, as described herein.

Aspects of the present disclosure provide techniques for automated prompts generated based on virtual meeting discussions. These techniques enable the use of AI models to generate or obtain meeting resources that are accessible to participants during or after a virtual meeting. In accordance with embodiments of the present disclosure, a platform can provide participants with access to automatically generated/updated meeting resources, preventing the participants from manually creating and updating such resources. Accordingly, participants of a virtual meeting can be engaged with the virtual meeting discussion, maintaining the flow of the conversation and, in some instances, reducing the overall time for the virtual meeting, which can decrease the overall amount of computing resources (e.g., processing cycles, memory space, network bandwidth, etc.) consumed during the virtual meeting. Further, the platform can provide late-joining participants access to the meeting resources obtained in accordance with embodiments described herein, allowing such participants to be caught up on what was previously covered during the meeting, further minimizing the number of distractions or disruptions during the virtual meeting. Further, embodiments of the present disclosure enable the generation of optimized prompts that cause AI models to perform requested operations more quickly and with fewer resources, while achieving a higher degree of accuracy. Accordingly, the AI models supporting the generation of meeting resources consume fewer computing resources overall, making these resources available for other processes. This increases overall system efficiency and decreases latency.

Implementations described herein may involve the collection of data describing a user and/or activities of a user. To address the privacy of users, various techniques may be implemented. In one implementation, the collection of such data occurs only after the user provides consent. In some implementations, a user may be presented with a prompt to explicitly allow the collection of this data. In the instance where the user consents to the use of such data, the data may be used for the described functionalities.

Prior to the system enabling collection of user information (e.g., facial features), a user may be provided with controls allowing the user to make an election as to both if and when the system may enable such collection. For in-room participants, clear and conspicuous information regarding the data collection may be provided before their participation. This information may include the fact that the system processes video to create facial embeddings for identification, and that full photographic images may not be stored. The purpose of this processing may be to provide individual recognition of in-room participants to enhance the virtual meeting experience. Details regarding how facial embeddings and associated identifiers may be used within the meeting context may also be provided.

In some implementations, users may be informed of the security measures in place to protect facial embeddings, such as encryption prior to being stored. Information regarding how long facial embeddings may be retained and the procedures for their removal may also be provided. Users may be informed of their options regarding their biometric data. Contact information for privacy-related questions may be made available. Methods of providing such information may include in-room displays or a companion application for in-room participants, and the platform user interface for remote participants.

In some implementations, the system may obtain an affirmative indication from in-room participants prior to facial identification. For instance, in the instance where a user consents to the association of a detected facial region with their identifier, the system may record this association. For automatic identification based on facial features, prior affirmative indication may be obtained for the enrollment and storage of these features. Alternative methods for in-room participants to indicate their presence without using facial recognition may be available. Participants may be informed of their ability to withdraw their consent and may be provided with mechanisms to do so, such as leaving camera view or using a user interface control. The consequences of withdrawing consent may be clearly communicated.

Users may have the ability to review and potentially modify their stored facial feature data. Users may also have the ability to remove their stored facial feature data. The ability to disable automatic identification within meeting or profile settings may be provided to users. If a misidentification occurs, mechanisms for a user to correct this may be available.

In some implementations, the system may store only facial embeddings derived from photos and may not retain the full photographic images. Client devices may, in some implementations, derive facial embeddings locally before sending them to a server. Biometric data processed for identification and association during a meeting may be temporary. Data describing facial features may be retained only for the minimum duration required for meeting functionality and may be removed shortly after the meeting concludes unless an affirmative indication is provided for longer retention to potentially improve future accuracy. The use of facial feature data may be limited to the purpose of identifying in-room participants within virtual meetings.

Data describing facial features may be treated in one or more ways before it is stored or used, so that personally identifiable information is removed. For example, a user's identity may be treated so that no personally identifiable information can be determined for the user. Access to stored facial feature data may be controlled to limit which components and personnel can access it.

The system may be designed to align with privacy considerations. Where technically viable, processing of facial features for matching may occur locally on the client device against a downloaded set of meeting participant features to reduce server-side processing. Measures to reduce the risk of unintentionally capturing and processing biometric data of individuals not participating in the meeting may be implemented. Privacy considerations may be addressed in the design of application programming interfaces (APIs), such as not retaining detailed data in logs and enforcing strong security for data retrieval. A description of the retention periods and data removal procedures for all collected and processed data related to this system may be documented.

Workspace administrators may be provided with controls to manage implementations within their domain, including the ability to enable or disable it for specific units or users and potentially remove enrollment data. Features for reviewing the usage of automatic identification may be implemented to support accountability.

It should be noted that although aspects of the present disclosure are described with reference to a conference room, they should not be so limited, and can be used in any other space or location allowing a group setting for participating users.

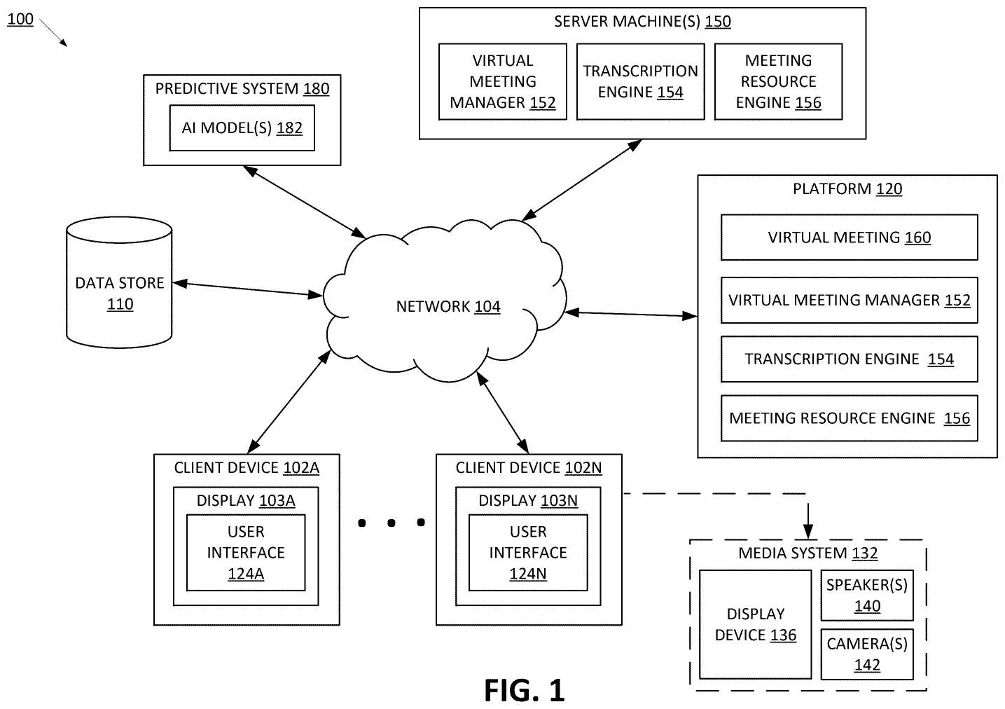

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, and/or one or more server machines 150, each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more video streams, audio streams, and/or meeting transcripts that can be used to generate meeting resources (e.g., at predetermined time intervals) and/or to generate the electronic documents (e.g., at a time after the end of the virtual meeting). Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

Platform 120 can enable users of client devices 102A-N to connect with each other via a virtual meeting (e.g., virtual meeting 160). The virtual meeting 160 can be a video-based virtual meeting, which includes a meeting during which a client device 102 connected to platform 120 captures and transmits video streams (e.g., collected by a camera of a client device 102) and/or audio streams (e.g., collected by a microphone of the client device 102) to other client devices 102 connected to platform 120. The video streams can, in some embodiments, depict a user or group of users that are participating in the virtual meeting 160 (also referred to as participants). The audio streams can include, in some embodiments, an audio recording of audio provided by the user or group of users during the virtual meeting 160. In additional or alternative embodiments, the virtual meeting 160 can be an audio-based virtual meeting, which includes a meeting during which a client device 102 captures and transmits audio streams (e.g., without generating and/or transmitting image streams) to other client devices 102 connected to platform 120. In some instances, a virtual meeting can include or otherwise be referred to as a conference call. In such instances, a video-based virtual meeting can include or otherwise be referred to as a video-based conference call and an audio-based virtual meeting can include or otherwise be referred to as an audio-based conference call.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” A client device 102 can include an audiovisual component that can generate audio and video streams to be transmitted to conference platform 120. In some implementations, the audiovisual component can include one or more devices (e.g., a microphone, etc.) that capture an audio stream representing audio provided by the user. The audiovisual component can generate audio data (e.g., an audio file) based on the captured audio stream. In some embodiments, the audiovisual component can additionally or alternatively include one or more devices (e.g., a speaker) that output data to a user associated with a particular client device 102. In some embodiments, the audiovisual component can additionally or alternatively include a video capture device (e.g., a camera) to capture videos streams and generate video data (e.g., a video file) based on the captured video streams.

In some embodiments, one or more client devices 102 can be devices of a physical conference room or a meeting room. Such client devices 102 can be included at or otherwise coupled to a media system 132 that includes one or more display devices 136, one or more speakers 140 and/or one or more cameras 142. A display device 136 can be, or can otherwise include, a smart display or a non-smart display (e.g., a display that is not itself configured to connect to platform 120 or other components of system 100 via network 104). Users that are physically present in the conference room or the meeting room can use a media system 132 rather than their own client devices 102 to participate in a virtual meeting, which may include other remote participants. For example, participants in the conference room or meeting room that participate in the virtual meeting may use display device 136 to share a slide presentation with, or watch a slide presentation of, other participants that are accessing the virtual meeting remotely. Sound and/or camera control can similarly be performed. As described above, a client device 102 connected to the media system 132 can generate media streams (e.g., audio and video streams) to be transmitted to platform 120 (e.g., using one or more microphones (not shown), speaker(s) 140 and/or camera(s) 142).

Client devices 102A-N can each include a content viewer, in some embodiments. In some implementations, a content viewer can be an application that provides a user interface (UI) (sometimes referred to as a graphical user interface (GUI)) for users to access the virtual meeting 160 hosted by platform 120. The content viewer can be included in a web browser and/or a client application (e.g., a mobile application, a desktop application, etc.). In one or more examples, a user of client device 102A can join and participate in the virtual meeting 160 via UI 124A presented via display 103A via the web browser and/or client application. A user can also present or otherwise share a document to other participants of the virtual meeting 160 via each of UIs 124A-124N. Each of UIs 124A-124N can include multiple regions that enable presentation of visual items corresponding to video streams of client devices 102A-102N provided to platform 120 during the virtual meeting 160.

In some embodiments, platform 120 can include a virtual meeting manager 152. Virtual meeting manager 152 can be configured to manage the virtual meeting 160 between two or more users of platform 120. In some embodiments, the virtual meeting manager 152 can provide the UI 124 to each of client devices 102 to enable users to watch and listen to each other during a video conference. The virtual meeting manager 152 can also collect and provide data associated with the virtual meeting 160 to each participant of the virtual meeting 160. For example, the virtual meeting manager 152 can provide documents that are associated with the virtual meeting 160 to one or more participants of the virtual meeting 160.

Platform 120 can additionally or alternatively include a transcription engine 154 that generates a transcript based on a discussion between participants of a virtual meeting 160. An engine, as described herein, refers to a component of a system (e.g., system 100) that powers and drives one or more functionalities of the system. An engine can be a software engine that includes or otherwise corresponds to a core program or set of operations that drive specific functionality within a system or application and/or a hardware engine that includes or otherwise corresponds to a physical component designed to perform specialized tasks. In some embodiments, transcription engine 154 can be an engine that is designed or otherwise configured to generate a transcript reflecting verbal statements and/or textual statements provided by participants during a virtual meeting 160.

In some embodiments, transcription engine 154 can generate a transcript by translating audio signal(s) collected by client device(s) 102 into a textual representation of the verbal statements provided during the discussion of the virtual meeting 160. For example, transcription engine 154 can perform one or more audio input processing operations to refine an audio signal (e.g., remove background noise, normalize volume, enhance speech clarity, etc.). The transcription engine 154 may then provide the refined audio signal as an input to one or more AI models that are trained to perform speech recognition operations (e.g., analyze audio signals to recognize and interpret human speech) and/or language modeling operations (e.g., predict a likely sequence of words or phrases based on grammar, context, and known vocabulary). The transcription engine can obtain one or more outputs of the AI models, which can include a textual representation of one or more verbal statements included in the audio signal. It should be noted that although some embodiments and examples of the present disclosure refer to AI-based transcript generation techniques, transcription engine 154 can generate the transcript in accordance with other techniques.

In some embodiments, transcription engine 154 can generate a live transcript of the discussion by processing audio signals collected by client device(s) 102 in real time (or approximately real time). Transcription engine 154 can provide the live transcript for presentation to participants of virtual meeting 160 via a UI 124, in some embodiments. In some embodiments, the live transcript can be continuously updated as participants continue a discussion of the virtual meeting 160. In other or similar embodiments, transcription engine 154 can generate a post-meeting transcript based on a recorded audio file or video file of the virtual meeting 160. The post-meeting transcript may reflect the entire conversation or discussion of the virtual meeting 160. In some embodiments, transcription engine 154 may generate the post-meeting transcript based on the live transcript, which is generated during the virtual meeting 160. For example, upon completion of the virtual meeting 160, transcription engine 154 may perform one or more transcript processing operations (e.g., speaker diarization operations, noise filtering operations, punctuation operations, etc.) to the live transcript generated throughout the virtual meeting 160.

As illustrated in FIG. 1, in some embodiments, platform 120 can additionally or alternatively include a meeting resource engine 156. Meeting resource engine 156 can generate or otherwise update a meeting resource associated with a virtual meeting 160. A meeting resource refers to meeting minutes (e.g., a record of points, discussions, and action items) for virtual meeting 160, a meeting summary (e.g., a high level summarization of topics discussed, key outcomes and decisions, and/or action items, etc.) for the virtual meeting 160, tasks associated with action items of the virtual meeting 160, and so forth. In some embodiments, meeting resource engine 156 generate an electronic document (e.g., a word processing document, a spreadsheet document, a slide presentation document, an electronic message document, etc.) that includes one or more meeting resources and can update the electronic document in accordance with a discussion of the virtual meeting 160. Meeting resource engine 156 can provide the electronic document (or one or more meeting resources of the electronic document) for presentation to a participant of the virtual meeting 160 (or another user of platform 120 that did not attend the virtual meeting 160) via a UI 124 of a client device 102. For example, meeting resource engine 156 can provide the electronic document and/or the meeting resource(s) for presentation via a UI for the virtual meeting 160 and/or via a UI for another application of platform 120 (e.g., after completion of the virtual meeting 160).

In some embodiments, meeting resource engine 156 may generate or otherwise update a meeting resource upon determining that an “automated meeting resource” functionality is enabled for the virtual meeting 160. In some embodiments, a participant of virtual meeting 160 can enable the automated meeting resource functionality by engaging with one or more UI elements of the virtual meeting UI. In other or similar embodiments, meeting resource engine 156 may detect a request (e.g., a verbal request, a textual request, etc.) to initiate the automated meeting resource functionality during a discussion between participants of the virtual meeting. In some embodiments, upon detecting that the automated meeting resource functionality is initiated, meeting resource engine 156 can generate a prompt associated with operations requested by participants of the virtual meeting 160 and, in some embodiments, can provide the generated prompt as an input to one or more AI model(s) 182, which are trained to perform the actions. In some embodiments, AI model(s) 182 can include one or more large language models that are trained to perform tasks or operations associated with a virtual meeting 160. The operations can include or otherwise correspond to preparing meeting minutes associated with the virtual meeting 160, preparing a meeting summary associated with the virtual meeting 160, generating tasks out of action items corresponding to one or more discussion points of a transcript (e.g., a live transcript or a post-meeting transcript), storing meeting notes associated with the virtual meeting 160 for later reference (e.g., at data store 110), presenting an electronic document via a UI 124 of a client device 102 of a participant, or generating a response to a question of a participant, and so forth. Further details regarding performing operations associated with AI model(s) 182 and generating a prompt for AI model(s) 182 are provided herein with respect to FIGS. 2-5.

It should be noted that although FIG. 1 illustrates the virtual meeting manager 152, transcription engine 154, and/or meeting resource engine 156 as part of platform 120, in additional or alternative embodiments, virtual meeting manager 152, transcription engine 154, and/or meeting resource engine 156 can reside on one or more server machines that are remote from platform 120 (e.g., server machine(s) 150). It should be noted that in some other implementations, the functions of platform 120, server machine(s) 150 and/or predictive system 180 can be provided by more or a fewer number of machines. For example, in some implementations, components and/or modules of platform 120, server machine(s) 150 and/or predictive system 180 may be integrated into a single machine, while in other implementations components and/or modules of any of platform 120, server machine(s) 150 and/or predictive system 180 may be integrated into multiple machines. In addition, in some implementations, components and/or modules of server machine(s) 150 and/or predictive system 180 may be integrated into platform 120.

In general, functions described in implementations as being performed by platform 120, server machine(s) 150, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces.

Although implementations of the disclosure are discussed in terms of platform 120 and users of platform 120 accessing the virtual meeting 160 hosted by platform 120, implementations of the disclosure are not limited to conference platforms and can be extended to any type of virtual meeting.

In implementations of the disclosure, a “user” can be represented as a single individual. However, other implementations of the disclosure can describe a “user” as an entity controlled by a set of users and/or an automated source. For example, a set of individual users federated as a community in a social network can be considered a “user.” In another example, an automated consumer can be an automated ingestion pipeline of platform 120.

In situations in which the systems discussed here collect personal information about users, or can make use of personal information, the users can be provided with an opportunity to control whether the platform 120, virtual meeting manager 152, transcription engine 154, and/or meeting resource engine 156 collects user information (e.g., information about a user's social network, social actions or activities, profession, a user's preferences, or a user's current location), or to control whether or how to receive content from the virtual meeting platform 120 or the virtual meeting manager 152 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 152.

FIG. 2 is a block diagram of an example meeting resource engine 156, in accordance with implementations of the present disclosure. As described above, platform 120 can provide users with access to tools and functionalities associated with a virtual meeting 160. For example, a user of client device 102A can participate in a virtual meeting 160 with other users (e.g., of client devices 102B-N) via one or more tools or functionalities provided by platform 120). Meeting resource engine 156 can generate or otherwise update meeting resource(s) 262 associated with virtual meeting 160. A meeting resource 262 can include meeting minutes of the virtual meeting 160, a meeting summary for the virtual meeting 160, a task for an action item discussed during the virtual meeting 160, and so forth. Meeting resource engine 156 can perform additional or alternative operations associated with a virtual meeting 160, in some embodiments. For example, meeting resource 262 can perform operations such as preparing meeting minutes associated with the virtual meeting 160, preparing a meeting summary associated with the virtual meeting 160, generating tasks out of action items corresponding to one or more discussion points of a transcript (e.g., a live transcript or a post-meeting transcript), storing meeting notes associated with the virtual meeting 160 for later reference (e.g., at data store 110), presenting an electronic document via a UI 124 of a client device 102 of a participant, or generating a response to a question of a participant, and so forth.

In some embodiments, meeting resource engine 156 can perform the operations described above based on one or more outputs of an AI model 182. As described herein, AI model 182 refers to a model (e.g., a LLM) that is trained to perform operations pertaining to a virtual meeting 160. As will be seen below, other types of AI models are used or otherwise accessed by meeting resource engine 156 (e.g., an intent classifier model 502, a discussion context model 504, a prompt generator 506, etc.). Although such models are also AI models, AI model 182, as described herein, is intended to refer to a model that is trained to perform operations pertaining to the virtual meeting 160. Such other models are referred to directly and individually, as seen below.

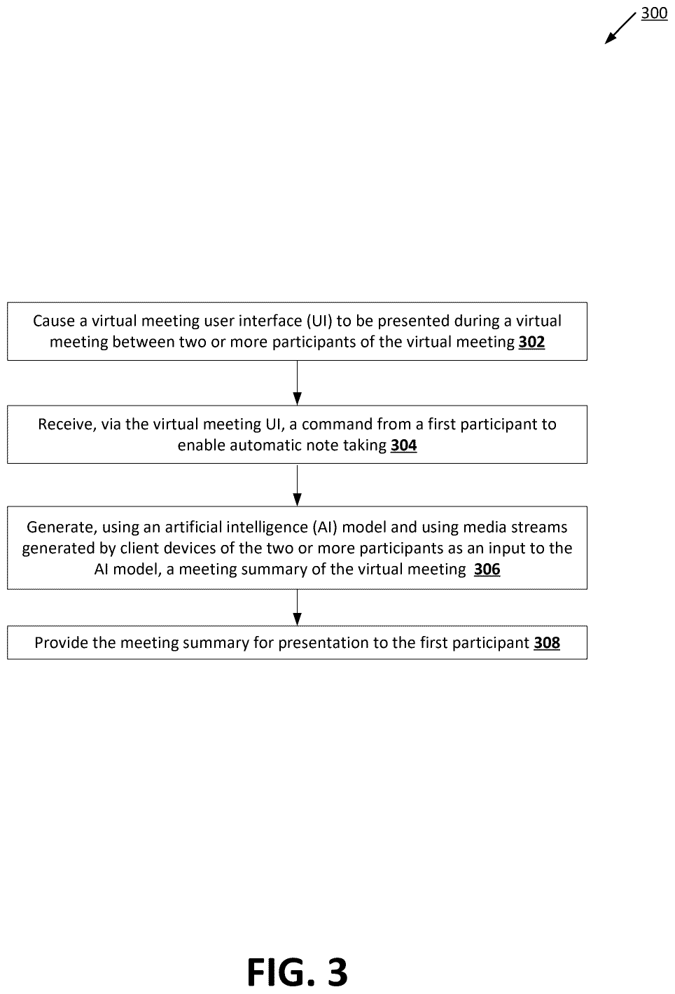

FIG. 3 depicts a flow diagram of an example method 300 for operation(s) performed by meeting resource engine 156 (e.g., generating a meeting summary of a virtual meeting 160), in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by meeting resource engine 156.

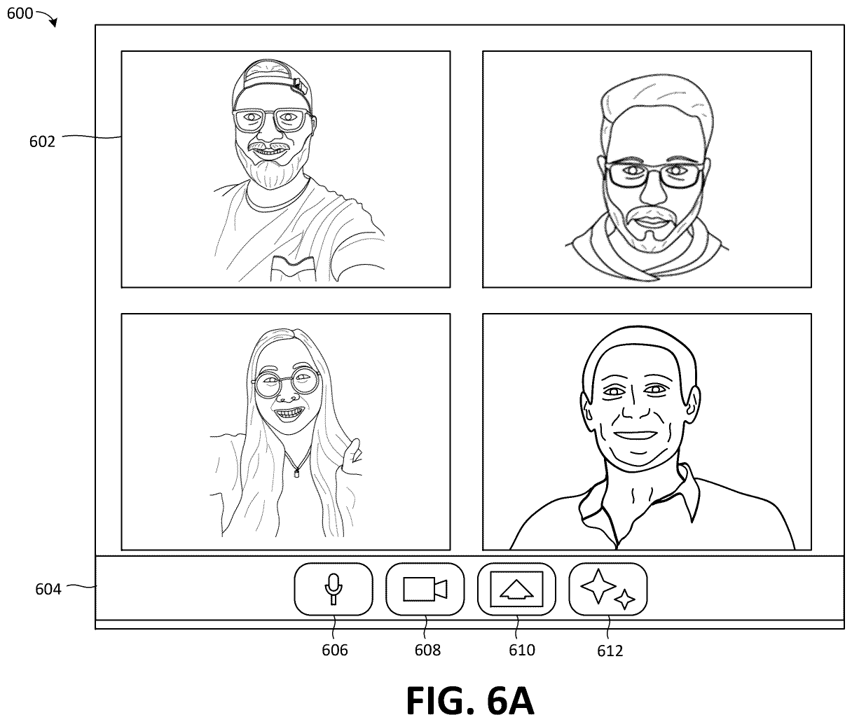

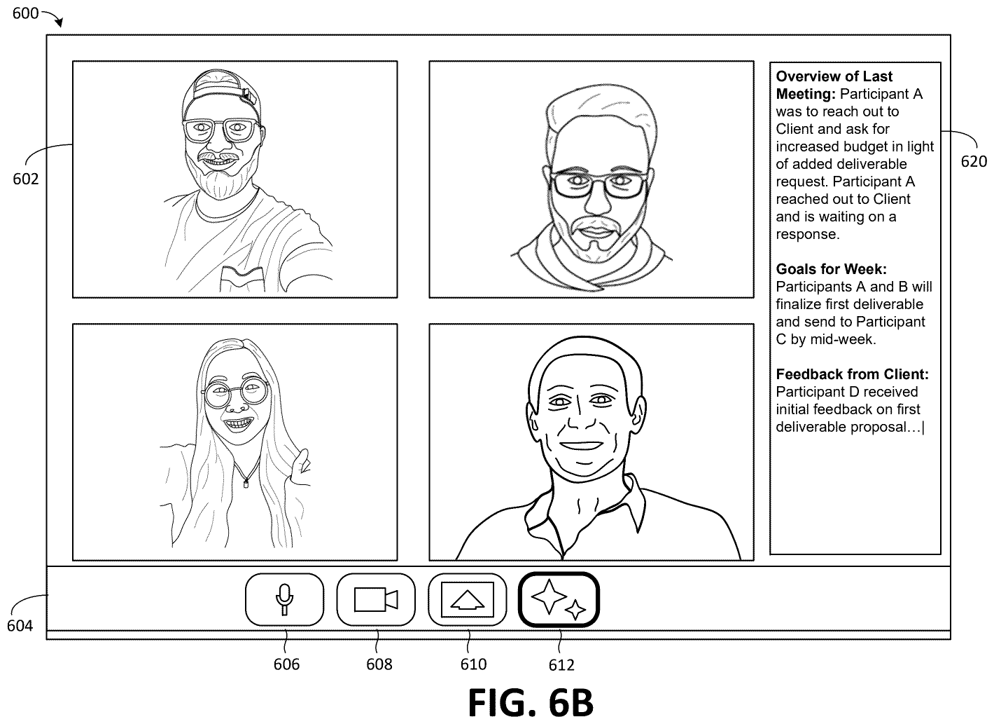

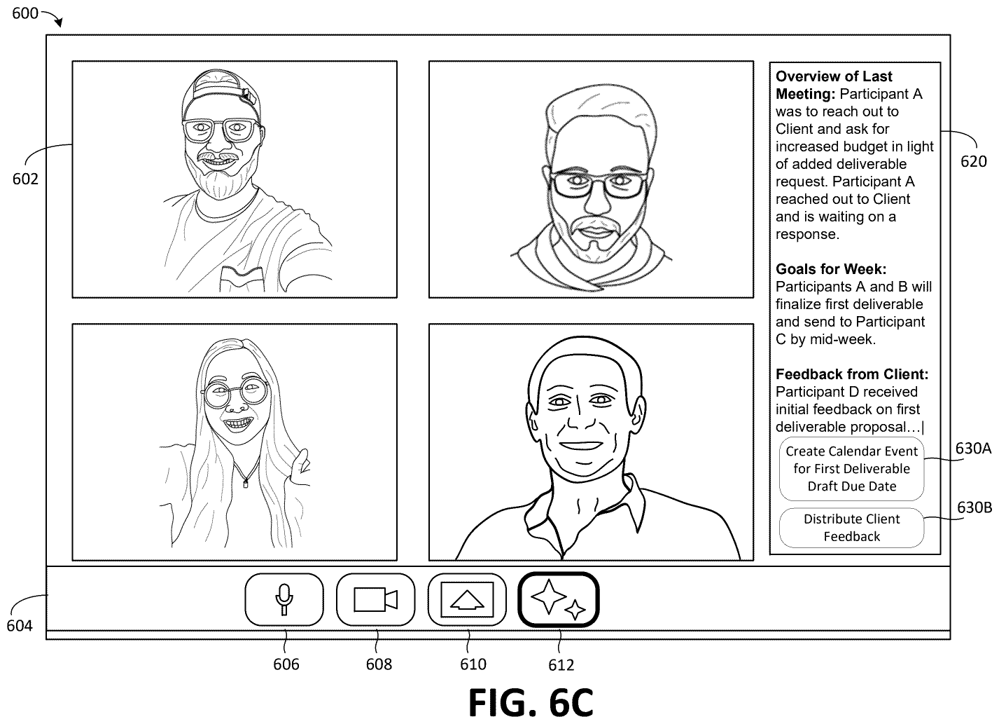

At block 302, processing logic causes a virtual meeting UI to be presented during a virtual meeting between two or more participants of the virtual meeting. As described herein, platform 120 can enable users to connect with other users (e.g., participants) of a virtual meeting 160 via tools or functionalities of platform 120. FIG. 6A illustrates an example virtual meeting UI 600 presented during a virtual meeting 160 via client device(s) 102 of two or more participants. As illustrated by FIG. 6A, the UI can include one or more regions 602 corresponding to a visual item of the virtual meeting 160, such as a video stream provided by a client device 102A-N of a participant of the virtual meeting 160. The virtual meeting UI 600 can include a tool bar 604 that includes one or more UI elements associated with virtual meeting operations. For example, as seen in FIG. 6, the tool bar 604 includes an audio control element 606 (e.g., that enables a participant to mute and unmute their audio stream), a camera control element 608 (e.g., that enables a participant to mute and unmute their video stream), and/or a screen share element 610 (e.g., that enables a participant to initiate a screen sharing operation to share a view of a client device 102 with other participants of the virtual meeting 122). In some embodiments, the tool bar 604 may include one or more UI elements 612 that enable a participant to initiate an automated meeting resource functionality, as described herein.

Referring back to FIG. 3, at block 304, processing logic receives, via the virtual meeting UI, a command from a first participant to enable automatic note taking. In some embodiments, a participant can engage with UI element 612 of UI 600 to provide a request to initiate the automated meeting resource functionality. As described above, the automated meeting resource functionality can involve or otherwise include generating or preparing meeting notes or a meeting summary based on a discussion of virtual meeting 160. A client device 102 associated with the participant can detect the engagement with the UI element 612 and can provide a notification of the detection to platform 120. Platform 120 can provide the notification to meeting resource engine 156, where the provided notification includes or otherwise corresponds to a command from the first participant to enable automatic note taking. In additional or alternative embodiments, a participant of virtual meeting 160 can provide the command in accordance with other techniques. For example, the participant can provide a verbal command and/or a text command (e.g., via a chat window of UI 600) to initiate the automated meeting resource functionality. Transcription engine 154 can generate a transcript of the virtual meeting 160 including the verbal command and/or the text command. Meeting resource engine 156 can identify the verbal command and/or the text command based on the generated transcript, in some embodiments. In yet additional or alternative embodiments, a participant of a virtual meeting 160 can engage with one or more other UI elements of FIG. 6A (elements that are illustrated or not illustrated) and meeting resource engine 154 may initiate the automated meeting resource functionality based on a detection of the engagement with the other UI elements. For example, a participant may engage with a UI element (not shown) associated with initiating a recording operation to generate an audio and/or video-based recording of the virtual meeting. Upon detecting the engagement, platform 120 can update the UI 600 to include an inquiry as to whether the participant would also like to initiate the automated meeting resource functionality and may initiate the functionality based on a user provided response to the inquiry.

At block 306, processing logic generates, using an AI model and using media streams generated by client devices of the two or more participants as an input to the AI model, a meeting summary of the virtual meeting. As described herein, meeting resource engine 154 may generate one or more prompts for the AI model based on a discussion of the participants during the virtual meeting 160. Meeting resource engine 154 can provide the generated prompt(s) as an input to the AI model to cause the AI model to perform operations associated with the virtual meeting 160. In accordance with the example of FIG. 3, the prompt(s) can correspond to or otherwise pertain to operations associated with generating the meeting summary of the virtual meeting 160. Upon providing the prompt(s) as an input to the AI model, meeting resource engine 154 can obtain one or more meeting resources (e.g., a summarization of the discussion points) as an output to the AI model.

At block 308, processing logic provides the meeting summary for presentation to the first participant. In some embodiments, meeting resource engine 154 can update UI 600 to present an obtained meeting resource (e.g., the meeting summary) to the participants of the virtual meeting 160 as the virtual meeting is being conducted. As illustrated by FIG. 6B, meeting resource engine 154 can update UI 600 to include the meeting summary generated by the AI model in an additional region 620 of UI 600.

Referring back to FIG. 2, meeting resource engine 156 can include a transcript component 210, a discussion intent component 212, a meeting context component 214, and/or a predictive component 216. Details regarding components of meeting resource engine 156 are provided herein with respect to FIG. 2 and FIGS. 4-5. Platform 120, predictive system 180, virtual meeting manager 152, transcription engine 154, and/or meeting resource engine 156 can be connected to a memory 250 (e.g., via network 104, via a bus, etc.). Memory 250 can include one or more portions of data store 110, in some embodiments. In other or similar embodiments, memory 250 can include or correspond to any memory of any component of system 100 and/or otherwise accessible to a component of system 100.

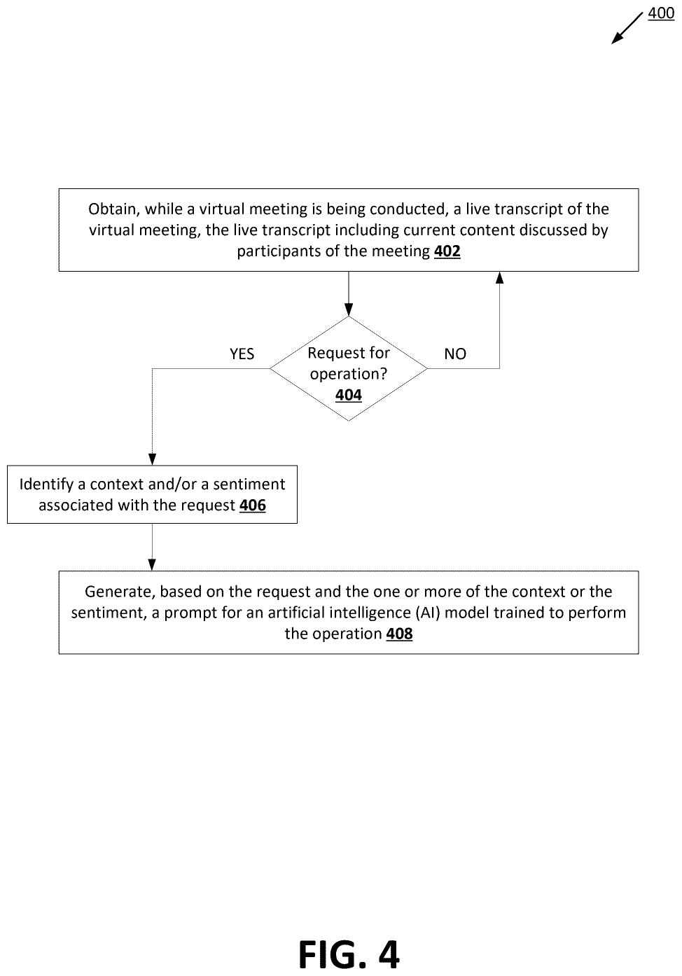

As described above, meeting resource engine 156 can generate a prompt that will cause an AI model 182 to perform one or more operations associated with a virtual meeting 160 (e.g., as requested by a user during the virtual meeting 160). FIG. 4 depicts a flow diagram of an example method 400 for automatic prompt generation based on a meeting discussion, in accordance with implementations of the present disclosure. Method 500 can be performed by processing logic that can include hardware (circuitry, dedicated logic, etc.), software (e.g., instructions run on a processing device), or a combination thereof. In one implementation, some or all the operations of method 500 can be performed by one or more components of system 100 of FIG. 1. In some embodiments, some or all of the operations of method 400 can be performed by meeting resource engine 156.

At block 402, processing logic obtains, while a virtual meeting is being conducted, a live transcript of the virtual meeting. The live transcript includes current content discussed by participants of the virtual meeting. In some embodiments, virtual meeting manager 152 (or another component of platform 120) can obtain discussion data 252 from one or more client devices 102 of participants of virtual meeting 160. The discussion data 252 can include audio signals generated by client device(s) 102 that represent verbal statements provided by the participants, in some embodiments. In other or similar embodiments, the discussion data 252 can include textual data or other such type data indicating textual statements of the participants. For example, two or more participants can participate in a chat discussion (e.g., via a chat functionality) during the virtual meeting 160. Discussion data 252 can include content and/or other metadata (e.g., time stamps, participant identifiers, etc.) associated with the chat discussion. Virtual meeting manager 152 can obtain the discussion data 252 and can provide the discussion data 252 to transcription engine 154 and/or can store the discussion data 252 at memory 250.

Transcription engine 154 can generate a transcript representing content of a discussion between participants of the virtual meeting 160, as described above. In some embodiments, transcription engine 154 can generate a live transcript, which reflects current content and/or prior content of the discussion between an initial time period of the virtual meeting 160 (e.g., when the virtual meeting 160 was started or scheduled to start) and a current time period of the virtual meeting 160. Transcription engine 154 can store the live transcript at memory 250 as meeting transcript 254, in some embodiments. In some embodiments, transcription engine 154 can update the meeting transcript 254 (e.g., continuously or periodically according to a transcription schedule defined for platform 120) based on the discussion throughout the virtual meeting 160. Transcript component 210 of meeting resource engine 156 can obtain meeting transcript 254 (e.g., from transcription engine 154 or from memory 250).

It should be noted that although some embodiments and examples of the present disclosure refer to generating the prompt based on information obtained based on a live transcript, embodiments and examples of the present disclosure can be applied to a post-meeting transcript, as described herein. For example, discussion data 252 can include or otherwise correspond to an audio and/or video file that includes a recording of the virtual meeting 160 (e.g., from an initial time period to a final time period of the virtual meeting). Transcription engine 154 can generate a post-meeting transcript based on such discussion data 252, as described herein, and meeting resource engine 156 may generate the prompt(s) for the AI model based on the post-meeting transcript, in some embodiments.

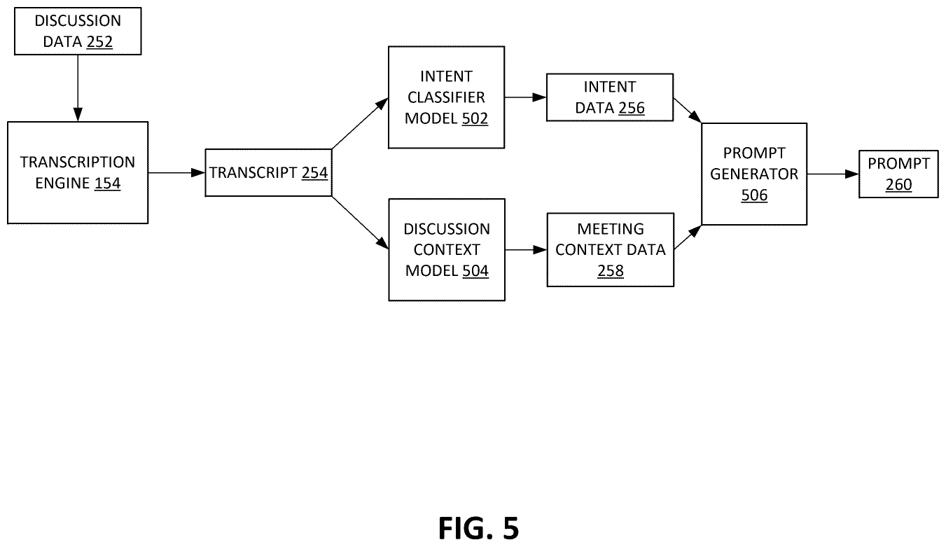

At block 404, processing logic determines, based on the live transcript, whether the current content indicates a request of a participant for an operation to be performed with respect to the virtual meeting. In some embodiments, discussion intent component 212 can determine an intent of one or more participants of the virtual meeting, where the intent can indicate a request for an operation to be performed with respect to the virtual meeting 160. In some embodiments, discussion intent component 212 can determine the intent of the one or more participants based on one or more outputs of an AI model, such as an intent classifier model 502 of FIG. 5. In some embodiments, intent classifier model 502 can be an AI model (e.g., a natural language processing (NLP) model) that is trained to predict an intent associated with a user query. An intent of a user query refers to a goal or purpose that the user wishes to accomplish from their input. In some embodiments, intent classifier model 502 can include a logic regression model, a support vector machine (SVM) model, a Naïve Bayes model, a long short-term memory (LSTM) model, a gated recurrent unit (GRU) model, a transformer-based model, and so forth.

In some embodiments, discussion intent component 212 can provide meeting transcript 254 as an input to intent classifier model 502. Discussion intent component 212 can perform one or more preprocessing operations with respect to meeting transcript 254, in some embodiments. For example, discussion intent component 212 can perform one or more of a tokenization operation, a lowercasing operation, a stopword removal operation, a lemmatization or stemming operation, and so forth to one or more text strings of meeting transcript 254. Discussion intent component 212 can additionally or alternatively extract or otherwise generate one or more features (e.g., vectors or embeddings) representing content of the meeting transcript 254 and provide the one or more features as an input to intent classifier model 502. Discussion intent component 212 can obtain one or more outputs of intent classifier model 502, which can indicate whether one or more portions of meeting transcript 254 correspond to an intent (e.g., a predefined intent) for an operation to be performed with respect to the virtual meeting 160. The intent indicated by the one or more outputs of the intent classifier model 502 can indicate or otherwise correspond to a request for the operation to be performed, as described above. Discussion intent component 212 can store the indication of the intent at memory 250 as intent data 256, in some embodiments.

Responsive to a determination that the current content indicates a request for the operation to be performed with respect to the virtual meeting, method 400 proceeds to block 406. At block 406, processing logic identifies a context and/or a sentiment associated with the request. In some embodiments, In some embodiments, meeting context component 214 of meeting resource engine 156 can determine a context or sentiment of the request by providing meeting transcript 254 (or a portion of meeting transcript 254 that includes the request of the participant) as an input to a discussion context model 504. A context of a request refers to a background, topic, or issue being addressed during the virtual meeting discussion in a time period prior to or when the request was made. The context can include, but is not limited to, a relevant part of the discussion, the participants involved, goals or challenges discussed, and/or any decisions or agreements that led to the request. A sentiment associated with the request refers to the emotional tone or attitude conveyed by the participant when the request was made. A sentiment may be neutral, positive (e.g., expressed with enthusiasm or agreement), urgent (e.g., reflecting time-sensitivity or importance), and so forth. In some instances, the sentiment of the request can indicate the priority behind the request and/or how it should be addressed or followed up.

In some embodiments, the discussion context model can be an NLP model (e.g., the same or similar to the type of model for intent classifier model 502) that is trained to predict a context and/or a sentiment of given input data. In some embodiments, meeting context component 216 can provide meeting transcript 254 as an input to discussion context model 504 (or can provide a portion of meeting transcript 254 including the request as an input to discussion model 504). Meeting context component 216 can provide additional or alternative data associated with virtual meeting 160 and/or participants of virtual meeting 160 as an input to discussion context model 504, which can include, but is not limited to, a title or name associated with virtual meeting 160, an agenda associated with virtual meeting 160, one or more electronic documents associated with virtual meeting 160 (or content of virtual meeting 160), a role or position of a respective participant of virtual meeting 160, and so forth. Meeting context component 216 can obtain one or more outputs of discussion context model 504, which can indicate a predicted context of the request and/or a predicted sentiment of virtual meeting 160 or the request. Meeting context component 216 can store the predicted context and/or the predicted sentiment at memory 250 as meeting context data 258.

At block 408, processing logic generates, based on the request and the one or more of the context or the sentiment, a prompt for an AI model trained to perform the operation. In some embodiments, predictive component 216 can generate the prompt 260 based on intent data 256 and meeting context data 258, as described above. In some embodiments, predictive component 216 can generate prompt 260 based on a pre-defined prompt template that corresponds to a type of the virtual meeting 160 and/or the operation of the request. For example, an operator or a developer can provide a set of pre-defined prompt templates, which each correspond to a respective type of virtual meeting 160 (e.g., an academic lecture, a team meeting, an interview, etc.) and/or a type of operation that can be performed with respect to a virtual meeting 160. Predictive component 216 can identify a pre-defined prompt template that corresponds to the type of the virtual meeting 160 and/or the operation, where the template includes one or more fields each associated with respective data items associated with virtual meeting 160 and/or the operation. In an illustrative example, a pre-defined prompt template can be associated with a request to generate a task for an action item identified in an team meeting (e.g., “Generate a task for {action item} directed to {participant identifier(s)} in {action item application identifier}, based on {sentiment} tone), where the pre-defined prompt template can include fields (e.g., { . . . }) that are to include intent data 256 and/or meeting context data 258. Predictive component 216 can generate the prompt 260 by inserting intent data 256 and/or meeting context data 258 into the relevant fields, in some embodiments.

In other or similar embodiments, predictive component 216 can generate prompt 260 by providing intent data 256 and/or meeting context data 258 as an input to a prompt generator 506 that is trained to generate a prompt 260 based on given input data. In some embodiments, prompt generator 506 can include a LLM or an encoder-decoder model that is trained to generate an optimized prompt 260 that, when provided as an input to an AI model 182, causes the AI model 182 to perform the operation associated with virtual meeting 160. Predictive component 2126 can provide intent data 256 and/or meeting context data 258 as an input to prompt generator 506 and can obtain one or more outputs, which can include a prompt 260 for AI model 182, as described above.

In some embodiments, predictive component 216 can provide the prompt 260 as an input to AI model 182 and can obtain one or more outputs. The one or more outputs of AI model 182 can include an outcome of the operation corresponding to the provided prompt 260. In some embodiments, the one or more outputs can include a meeting resource 262 (e.g., meeting minutes, a meeting summary, etc.), in accordance with embodiments described herein. In some embodiments, predictive component 216 may provide prompt 260 as an input to AI model 182 in response to an additional request by a participant of virtual meeting 160. For example, as illustrated by FIG. 6C, meeting resource engine 156 can update UI 600 to include one or more additional UI elements 630 that each correspond to a respective operation indicated by current content of meeting transcript 254 (e.g., “Create Calendar Event for First Deliverable Draft Due Date,” “Distribute Client Feedback,” etc.). Meeting resource engine 156 may generate prompts for each respective operation, as described above and, prior to feeding such prompts as an input to AI model 182, may update UI 600 to include such additional UIs 630. In some embodiments, predictive component 216 can provide a prompt associated with a respective operation as an input to AI model 182 based on a detection of a user interaction with a respective UI element 630 corresponding to the operation.

Referring back to FIG. 4, responsive to a determination at block 404 that the current content does not indicate a request for the operation to be performed with respect to the virtual meeting, method 400 returns to block 402. Meeting resource engine 156 can continuously or periodically evaluate meeting transcript 254 (e.g., as the discussion occurs between participants of virtual meeting 160) to determine whether operations associated with virtual meeting 160 are requested, as described herein.

It should be noted that although embodiments and examples of the present disclosure describe generating prompt 260 based on outputs of at least three individual AI models (e.g., intent classifier model 502, discussion context model 504, prompt generator 506), a single AI model can be trained to classify an intent of a request, determine a context or sentiment of the request, and/or generate a prompt based on the intent, context, and/or the sentiment, as described herein.

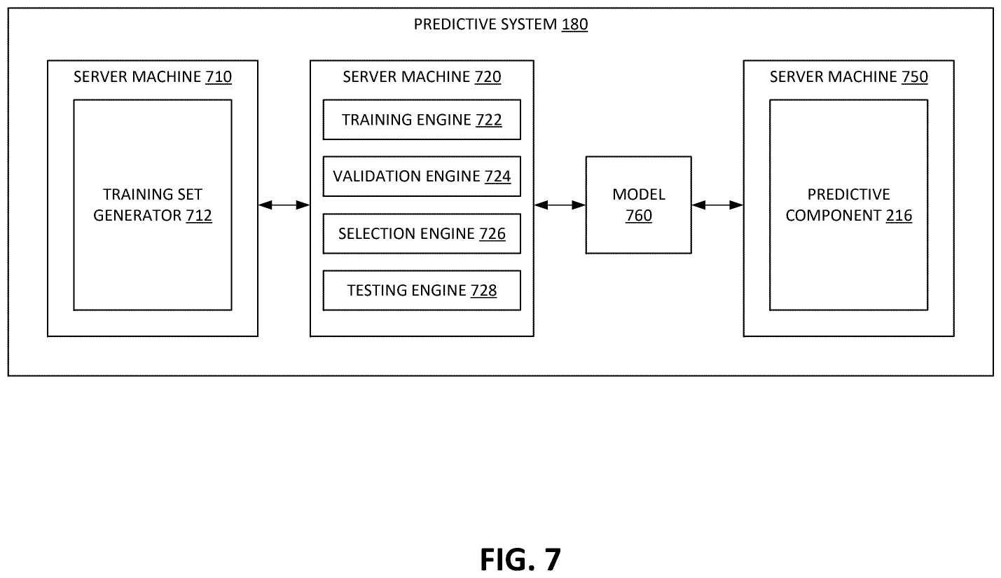

FIG. 7 illustrates an example predictive system, in accordance with implementations of the present disclosure. As illustrated in FIG. 7, predictive system 180 can include a training set generator 712 (e.g., residing at server machine 710), a training engine 712, a validation engine 724, a selection 726, and/or a testing engine 728 (e.g., each residing at server machine 720), and/or a predictive component 752 (e.g., residing at server machine 750). Training set generator 712 may be capable of generating training data (e.g., a set of training inputs and a set of target outputs) to train one or more AI model 760 (e.g., AI model 182, intent classifier model 502, discussion context model 504, prompt generator 506, etc.).

In some embodiments, one or more of AI model(s) 760 (e.g., AI model 182) can include a general purpose model that is trained to perform a wide variety of tasks. In such embodiments, training set generator 712 can generate a training data set for training AI model 182 based on a corpus of textual data, audio data, video data, and so forth. The corpus can include a wide array of information gathered from numerous sources, including publicly available web pages (e.g., blogs, forums, news sites, academic papers, online encyclopedias, etc.), books and literature, social media, research papers, public datasets, and so forth. Training set generator 712 can extract features from data of the corpus and can transform the extracted features into a format that the AI model 182 can interpret. In some embodiments, training set generator 712 can perform one or more tokenization operations (e.g., to break down the textual data, audio data, video data, etc. into smaller units called tokens), one or more normalization operations (e.g., to convert the tokens into a common format and/or a format that can be handled by the AI model 182), one or more noise removal operations (e.g., to remove or filter out unwanted data or metadata), and/or one or more data formatting operations (e.g., to structure the tokens uniformly and indicate contextual windows between tokens indicating dependencies between tokens). In some embodiments, training set generator 712 can obtain annotation data for the tokens obtained based on the data of the corpus. Annotation data can include an indication of a classification associated with the token. In some embodiments, the annotation data can be provided by human annotators or according to other annotation techniques. Training set generator 712 can update the training data set to include the extracted features, the generated tokens, and/or the annotation data. As described below, training engine 722 can use the training data to perform the wide range of tasks.

In other or similar embodiments, one or more AI model(s) 760 can include specific purpose models that are trained to perform specific tasks or operations, in accordance with embodiments described herein. For example, intent classifier model 502 can be a specific purpose model that is trained to predict an intent of a user query, as described herein. In some embodiments, intent classifier model 502 can be trained according to supervised learning techniques based on a training data set that trains intent classifier model 502 into one of several predefined intent classes. In some embodiments, the predefined intent classes can correspond to operations that can be performed by AI model 182. For example, the predefined intent classes can correspond to requests or instructions to prepare meeting minutes associated with a virtual meeting 160, prepare a meeting summary associated with a virtual meeting 160, generate tasks out of action items corresponding to one or more discussion points of a transcript, store meeting notes associated with a virtual meeting 160 for later reference, present an electronic document via a UI 124 of a client device 102, generate a response to a question of a participant, and so forth. In some embodiments, the predefined intent classes can be provided by a developer or operator of system 100. In other or similar embodiments, the predefined intent classes can be determined based on historical data associated with system 100. Training set generator 712 can obtain historical user queries provided by users of platform 120 and can determine whether each respective historical user query corresponds to a predefined intent class (e.g., as provided by the developer or operator of system 100). In some embodiments, a historical user query can include or otherwise correspond to a request (e.g., a verbal request, a textual request) provided by a participant of a historical virtual meeting 160. In other or similar embodiments, the historical user query can be provided by users of other applications of platform 120 and/or other platforms 120 or systems 100. Training set generator 712 can generate training data for training intent classifier model 502 by generating a mapping between a historical user query, an indication of whether the historical user query corresponds to a predefined intent class and, if so, the corresponding predefined intent class.

In yet other or similar embodiments, discussion context model 504 can be a specific purpose model that is trained to predict a context and/or a sentiment of given input data. In some embodiments, discussion context model 504 can be trained according to supervised learning techniques based on a training data set that trains discussion context model 504 into one of several predefined context or sentiment classes. In some embodiments, the predefined context or sentiment classes can be provided by a developer or operator of system 100 and/or determined based on historical data associated with system 100. Training set generator 712 can obtain historical user queries or statements provided by users of platform 120 and can determine a context or sentiment associated with each respective query or statement (e.g., as provided by the developer or operator of system 100). In other or similar embodiments, the historical user query or statement can be provided by users of other applications of platform 120 and/or other platforms 120 or systems 100. Training set generator 712 can generate training data for training discussion context model 504 by generating a mapping between a historical user query or statement, a context of the query or statement, and/or a sentiment of the query or statement.

In yet other or similar embodiments, prompt generator 506 can be a specific purpose model that is trained to generate an optimized prompt for an AI model 182 based on given input data. In some embodiments, prompt generator 506 can be trained according to LLM techniques. For example, training set generator 712 can generate a training data set for prompt generator 506 that includes target prompts written by humans or by LLMs. In some embodiments, the training data set can additionally or alternatively include few-shot examples and/or model output scores associated with the target prompts.

Training engine 722 can train an AI model 760 using the training data from training set generator 712, as described above. The model 760 can refer to the model artifact that is created by the training engine 722 using the training data that includes training inputs and/or corresponding target outputs (correct answers for respective training inputs). The training engine 722 can find patterns in the training data that map the training input to the target output (the answer to be predicted), and provide the model 760 that captures these patterns. The model 760 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

In some embodiments, training engine 722 can first pre-train the AI model 760 on a corpus of text (e.g., generated by or accessible to training set generator 712 and/or training engine 722) to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 760 can then be further trained and/or fine-tuned on organizational data, including proprietary organizational data. The AI model 760 can also be further trained and/or fine-tuned on organizational data associated with a virtual meeting 160 and/or other documents, including proprietary organizational data associated with a virtual meeting 160 and/or other documents.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 760 while training may be ranked by a user, according to a variety of factors, including accuracy, helpfulness, veracity, acceptability, or any other metric useful in the fine-tuning portion of training. In this manner, the AI model 760 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 760 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 760 may be one or more of decision trees, random forests, support vector machines, or other types of machine learning models. In one embodiment, the AI model 760 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 760 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 760 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

Validation engine 724 may be capable of validating a trained model 760 using a corresponding set of features of a validation set from training set generator 712. The validation engine 724 may determine an accuracy of each of the trained models 760 based on the corresponding sets of features of the validation set. The validation engine 724 may discard a trained model 760 that has an accuracy that does not meet a threshold accuracy. In some embodiments, the selection engine 726 may be capable of selecting a trained model 760 that has an accuracy that meets a threshold accuracy. In some embodiments, the selection engine 726 may be capable of selecting the trained model 760 that has the highest accuracy of the trained models 760.

The testing engine 786 may be capable of testing a trained model 760 using a corresponding set of features of a testing set from training set generator 712. For example, a first trained model 760 that was trained using a first set of features of the training set may be tested using the first set of features of the testing set. The testing engine 728 may determine a trained model 760 that has the highest accuracy of all of the trained machine learning models based on the testing sets.

As described herein, predictive component 752 of server 750 (or another component of meeting resource engine 156) may be configured to feed data as input to model 760 and obtain one or more outputs. In some embodiments, predictive component 752 can include or be associated with meeting resource engine 156.

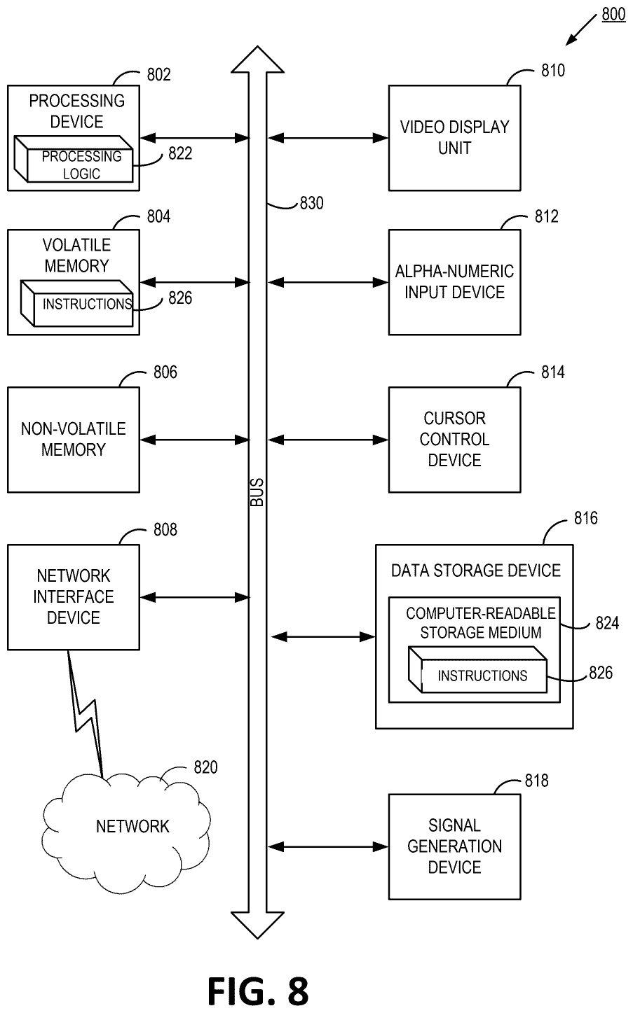

FIG. 8 is a block diagram illustrating an example computer system 800, in accordance with implementations of the present disclosure. The computer system 800 can correspond to platform 120 and/or client devices 102A-N, described with respect to FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a volatile memory 804 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 806 (e.g., flash memory, static random access memory (SRAM), etc.), and a data storage device 816, which communicate with each other via a bus 830.

Processor (processing device) 802 represents one or more general-purpose processing devices such as a microprocessor, central processing unit, or the like. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application specific integrated circuit (ASIC), a field programmable gate array (FPGA), a digital signal processor (DSP), network processor, or the like. The processor 802 is configured to execute processing logic 822 for performing the operations discussed herein.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (also computer-readable storage medium) on which is stored one or more sets of instructions 826 embodying any one or more of the methodologies or functions described herein. The instructions can also reside, completely or at least partially, within the volatile memory 804 and/or within the processor 802 during execution thereof by the computer system 800, the volatile memory 804 and the processor 802 also constituting machine-readable storage media. The instructions can further be transmitted or received over a network 820 via the network interface device 808.

In one implementation, the instructions 826 include instructions for providing fine-grained version histories of electronic documents at a platform. While the computer-readable storage medium 824 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include the collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining, while a virtual meeting is being conducted, a live transcript of the virtual meeting, the live transcript comprising current content discussed by a plurality of participants of the virtual meeting;
determining, based on the live transcript, whether the current content indicates a request of a participant of the plurality of participants for an operation to be performed with respect to the virtual meeting;
responsive to determining that the current content indicates the request of the participant for the operation, identifying one or more of a context or a sentiment associated with the request; and
generating, based on the request and the one or more of the context or the sentiment, a prompt for an artificial intelligence (AI) model, wherein the AI model is trained to perform the operation with respect to the virtual meeting.

2. The method of claim 1, wherein the operation comprises at least one of:
preparing meeting minutes associated with the virtual meeting,
preparing a meeting summary associated with the virtual meeting,
generating tasks out of action items corresponding to one or more discussion points of the live transcript,
storing meeting notes associated with the virtual meeting for later reference,
presenting an electronic document via a user interface (UI) of a client device of the participant, or
generating a response to a question of the participant.

3. The method of claim 1, wherein obtaining the live transcript of the virtual meeting comprises:
detecting, during the virtual meeting, an audio signal representing one or more verbal statements of a respective participant of the plurality of participants;
providing the audio signal as an input to a transcription engine;
obtaining one or outputs of the transcription engine, the one or more outputs comprising a textual version of the one or more verbal statements of the respective participant; and
updating the live transcript of the virtual meeting to include the textual version of the one or more verbal statements.

4. The method of claim 1, wherein determining whether the current content indicates a request of the participant for the operation comprises:
providing at least a portion of the live transcript as an input to an intent classifier model; and
obtaining one or more outputs of the intent classifier model, wherein the one or more outputs comprise an indication of whether the portion of the live transcript comprises a reference to one or more operations to be performed with respect to the virtual meeting,
wherein the determination of whether the current content indicates the request of the participant is made based on the obtained one or more outputs of the intent classifier model.

5. The method of claim 1, wherein identifying one or more of the context or the sentiment associated with the request comprises:
providing at least a portion of the live transcript as an input to a discussion context model; and
obtaining one or more outputs of the discussion context model, wherein the one or more outputs comprise an indication of at least one of a predicted context or a predicted sentiment of a discussion corresponding to the least the portion of the live transcript,
wherein the identified one or more of the context or the sentiment associated with the request comprises the at least one of the predicted context or the predicted sentiment.

6. The method of claim 1, further comprising:
updating a user interface (UI) of a client device associated with the participant to include a UI element corresponding to the operation with respect to the virtual meeting, wherein the live transcript of the virtual meeting comprises an indication of a detection of a user interaction with the UI element,
wherein determining whether the current content indicates the request of the participant for the operation to be performed with respect to the virtual meeting is based on the indication of the detection of the user interaction with the UI element.

7. The method of claim 6, further comprising:
determining a plurality of operations pertaining to one or more of an additional context or an additional sentiment associated with prior content of the live transcript, wherein the plurality of operations comprise the operation; and
updating the UI to include a plurality of UI elements each corresponding to a respective operation of the plurality of operations, the plurality of UI elements comprising the UI element corresponding to the operation.

8. The method of claim 1, wherein generating the prompt for the AI model comprises:
providing the request and the one or more of the context or the sentiment as an input to a prompt generator model;
obtaining one or more outputs of the prompt generator model, the one or more outputs comprising one or more prompts and, for each of the one or more prompts, an indication of a level of confidence that a respective prompt corresponds to an optimized prompt for the request; and
determining that the prompt for the AI model is associated with a level of confidence that satisfies one or more confidence criteria.

9. The method of claim 1, further comprises:
identifying a pre-defined prompt template that corresponds to at least one of a meeting type associated with the virtual meeting or an operation type associated with the operation,
wherein the prompt for the AI model is further generated based on the identified pre-defined prompt template.

10. A system comprising:
a memory; and
a processing device, coupled to the memory, configured to perform operations comprising:
obtaining, while a virtual meeting is being conducted, a live transcript of the virtual meeting, the live transcript comprising current content discussed by a plurality of participants of the virtual meeting;
determining, based on the live transcript, whether the current content indicates a request of a participant of the plurality of participants for an operation to be performed with respect to the virtual meeting;
responsive to determining that the current content indicates the request of the participant for the operation, identifying one or more of a context or a sentiment associated with the request; and
generating, based on the request and the one or more of the context or the sentiment, a prompt for an artificial intelligence (AI) model, wherein the AI model is trained to perform the operation with respect to the virtual meeting.

11. The system of claim 10, wherein the operation comprises at least one of:
preparing meeting minutes associated with the virtual meeting,
preparing a meeting summary associated with the virtual meeting,
generating tasks out of action items corresponding to one or more discussion points of the live transcript,
storing meeting notes associated with the virtual meeting for later reference,
presenting an electronic document via a user interface (UI) of a client device of the participant, or
generating a response to a question of the participant.

12. The system of claim 10, wherein obtaining the live transcript of the virtual meeting comprises:
detecting, during the virtual meeting, an audio signal representing one or more verbal statements of a respective participant of the plurality of participants;
providing the audio signal as an input to a transcription engine;
obtaining one or outputs of the transcription engine, the one or more outputs comprising a textual version of the one or more verbal statements of the respective participant; and
updating the live transcript of the virtual meeting to include the textual version of the one or more verbal statements.

13. The system of claim 10, wherein determining whether the current content indicates a request of the participant for the operation comprises:
providing at least a portion of the live transcript as an input to an intent classifier model; and
obtaining one or more outputs of the intent classifier model, wherein the one or more outputs comprise an indication of whether the portion of the live transcript comprises a reference to one or more operations to be performed with respect to the virtual meeting,
wherein the determination of whether the current content indicates the request of the participant is made based on the obtained one or more outputs of the intent classifier model.

14. The system of claim 10, wherein identifying one or more of the context or the sentiment associated with the request comprises:
providing at least a portion of the live transcript as an input to a discussion context model; and
obtaining one or more outputs of the discussion context model, wherein the one or more outputs comprise an indication of at least one of a predicted context or a predicted sentiment of a discussion corresponding to the least the portion of the live transcript,
wherein the identified one or more of the context or the sentiment associated with the request comprises the at least one of the predicted context or the predicted sentiment.

15. The system of claim 10, wherein the operations further comprise:
updating a user interface (UI) of a client device associated with the participant to include a UI element corresponding to the operation with respect to the virtual meeting, wherein the live transcript of the virtual meeting comprises an indication of a detection of a user interaction with the UI element,
wherein determining whether the current content indicates the request of the participant for the operation to be performed with respect to the virtual meeting is based on the indication of the detection of the user interaction with the UI element.

16. A non-transitory computer readable storage medium comprising instructions that, when executed by a processing device, cause the processing device to perform operations comprising:
obtaining, while a virtual meeting is being conducted, a live transcript of the virtual meeting, the live transcript comprising current content discussed by a plurality of participants of the virtual meeting;
determining, based on the live transcript, whether the current content indicates a request of a participant of the plurality of participants for an operation to be performed with respect to the virtual meeting;
responsive to determining that the current content indicates the request of the participant for the operation, identifying one or more of a context or a sentiment associated with the request; and
generating, based on the request and the one or more of the context or the sentiment, a prompt for an artificial intelligence (AI) model, wherein the AI model is trained to perform the operation with respect to the virtual meeting.

17. The non-transitory computer readable storage medium of claim 16, wherein the operation comprises at least one of:
preparing meeting minutes associated with the virtual meeting,
preparing a meeting summary associated with the virtual meeting,
generating tasks out of action items corresponding to one or more discussion points of the live transcript,
storing meeting notes associated with the virtual meeting for later reference,
presenting an electronic document via a user interface (UI) of a client device of the participant, or
generating a response to a question of the participant.

18. The non-transitory computer readable storage medium of claim 16, wherein obtaining the live transcript of the virtual meeting comprises:
detecting, during the virtual meeting, an audio signal representing one or more verbal statements of a respective participant of the plurality of participants;
providing the audio signal as an input to a transcription engine;
obtaining one or outputs of the transcription engine, the one or more outputs comprising a textual version of the one or more verbal statements of the respective participant; and
updating the live transcript of the virtual meeting to include the textual version of the one or more verbal statements.

19. The non-transitory computer readable storage medium of claim 16, wherein determining whether the current content indicates a request of the participant for the operation comprises:
providing at least a portion of the live transcript as an input to an intent classifier model; and
obtaining one or more outputs of the intent classifier model, wherein the one or more outputs comprise an indication of whether the portion of the live transcript comprises a reference to one or more operations to be performed with respect to the virtual meeting,
wherein the determination of whether the current content indicates the request of the participant is made based on the obtained one or more outputs of the intent classifier model.

20. The non-transitory computer readable storage medium of claim 16, wherein identifying one or more of the context or the sentiment associated with the request comprises:
providing at least a portion of the live transcript as an input to a discussion context model; and
obtaining one or more outputs of the discussion context model, wherein the one or more outputs comprise an indication of at least one of a predicted context or a predicted sentiment of a discussion corresponding to the least the portion of the live transcript,
wherein the identified one or more of the context or the sentiment associated with the request comprises the at least one of the predicted context or the predicted sentiment.
